(19) United States
(12) Patent Application Publication
(10) Pub. No.: US 2013/0129121 A1
(43) Pub. Date: May 23, 2013

(54) ELECTROSTATIC LOUDSPEAKER AND METHOD OF PRODUCING ELECTROSTATIC LOUDSPEAKER

(71) Applicant: YAMAHA CORPORATION, Hamamatsu-shi (JP)

(72) Inventor: Masayoshi YAMASHITA, Hamamatsu-shi (JP)

(73) Assignee: YAMAHA CORPORATION, Hamamatsu-shi (JP)

(21) Appl. No.: 13/741,512

(22) Filed: Jan. 15, 2013

Related U.S. Application Data
(63) Continuation of application No. PCT/JP2011/065903, filed on Jul. 12, 2011.

(30) Foreign Application Priority Data
Jul. 15, 2010 (JP) 2010-160871
Apr. 12, 2011 (JP) 2011-088422

(51) Int. Cl. H04R 19/02; H04R 31/00

(52) U.S. Cl. CPC H04R 19/02; H04R 31/00
USPC 381/191; 29/594

(57) ABSTRACT

An electrostatic loudspeaker includes: a first electrode; a second electrode which is opposed to the first electrode; and a vibrating member which is disposed between the first electrode and the second electrode and in which an insulation membrane and a conductive membrane are stacked, the insulation membrane being disposed on both end faces of the vibrating member in a direction of the stacking.

### CROSS-REFERENCE TO RELATED APPLICATION(S)

This application is based upon and claims the benefit of priority from prior Japanese patent applications No. 2010-160871 filed on Jul. 15, 2010 and No. 2011-088422 filed on Apr. 12, 2011, and an international application No. PCT/JP2011/065903 filed on Jul. 12, 2012, the entire contents of which are incorporated herein by reference.

### BACKGROUND

The presently disclosed subject matter relates to an electrostatic loudspeaker and a method of producing an electrostatic loudspeaker.

As an electrostatic loudspeaker having flexibility and being foldable or bendable, the electrostatic loudspeaker disclosed in JP-A-2008-54154 is available, for example. In this electrostatic loudspeaker, a polyester film on which aluminum is evaporated is held between two pieces of cloth woven with conductive threads, and ester wool is disposed between the film and the cloth. In the electrostatic loudspeaker, the polyester film serves as a vibrating member that generates sound, and the two pieces of cloth serve as electrodes that vibrate the vibrating member.

In the electrostatic loudspeaker disclosed in JP-A-2008-54154, aluminum is evaporated on one face of the vibrating member and the other face is formed of the polyester film. In this case, on the side of the polyester film, since the polyester has insulation property, dielectric strength voltage can be securely obtained between the electrode and the vibrating member. On the other hand, on the side of the vibrating member on which aluminum is evaporated, dielectric strength voltage cannot be securely obtained in comparison with the side of the polyester film, whereby a difference occurs in dielectric strength voltage between the one face and the other face of the vibrating member.

More specifically, discharge and short circuit are more apt to occur on the conductive layer side of the vibrating member in comparison with the insulation layer side thereof. In particular, in such a configuration in which electrodes and a vibrating member are bendable as in the case of the related art disclosed in JP-A-2008-54154, a damping member between each electrode and the vibrating member may be deformed by folding or bending and the distance between the electrode and the conductive layer may become shorter, or the electrode may penetrate into the damping member by folding or bending and the distance between the electrode and the conductive layer may become shorter in some cases, whereby there is a high possibility that discharge and short circuit are apt to occur.

### SUMMARY

The presently disclosed subject matter may suppress a difference between the dielectric strength voltage between one electrode and a vibrating member on one face side of the vibrating member opposed to the electrode and the dielectric strength voltage between the other electrode and the vibrating member on the other face side of the vibrating member.

The electrostatic loudspeaker of the presently disclosed subject matter may comprise: a first electrode; a second electrode which is opposed to the first electrode; and a vibrating member which is disposed between the first electrode and the second electrode and in which an insulation membrane and a conductive membrane are stacked, the insulation membrane being disposed on both end faces of the vibrating member in a direction of the stacking.

### BRIEF DESCRIPTION OF THE DRAWINGS

FIG. 1 is an external view showing an electrostatic loudspeaker according to an embodiment of the presently disclosed subject matter;

FIG. 2 is a sectional view taken on line A-A of FIG. 1;

FIG. 3 is an exploded view of the electrostatic loudspeaker;

FIG. 4 is a view showing the electrical configuration of the electrostatic loudspeaker;

FIG. 5 is an exploded view of an electrostatic loudspeaker according to a modification;

FIGS. 6(a), 6(b) and 6(c) are perspective views showing vibrating members according to modifications;

FIG. 7 is a schematic view showing an apparatus for producing a sheet having an insulation layer and a conductive layer stacked thereon; and

FIG. 8 is a schematic view showing a sheet having an insulation layer and a conductive layer stacked thereon.

### DETAILED DESCRIPTION OF EXEMPLARY EMBODIMENTS

### Embodiment

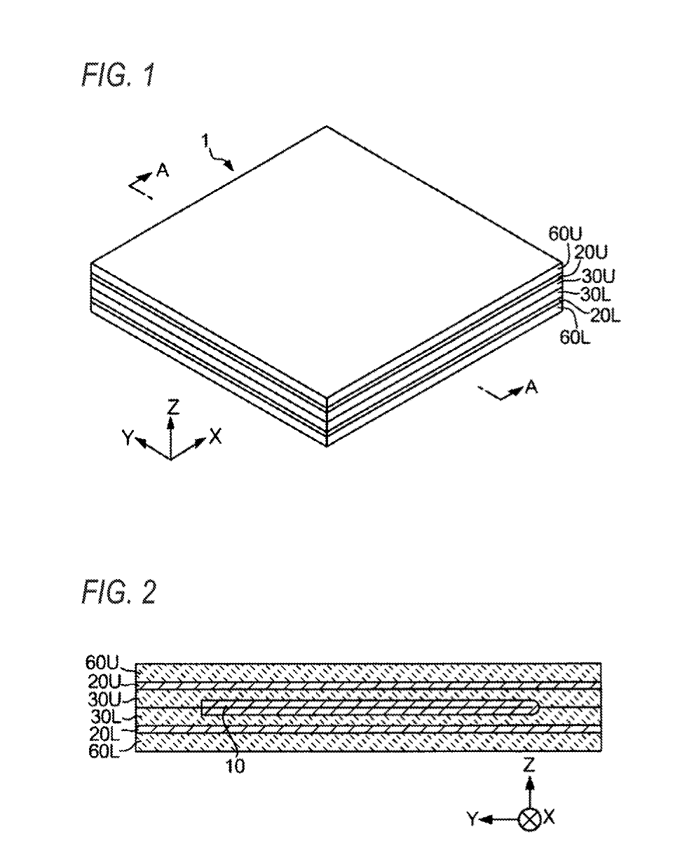

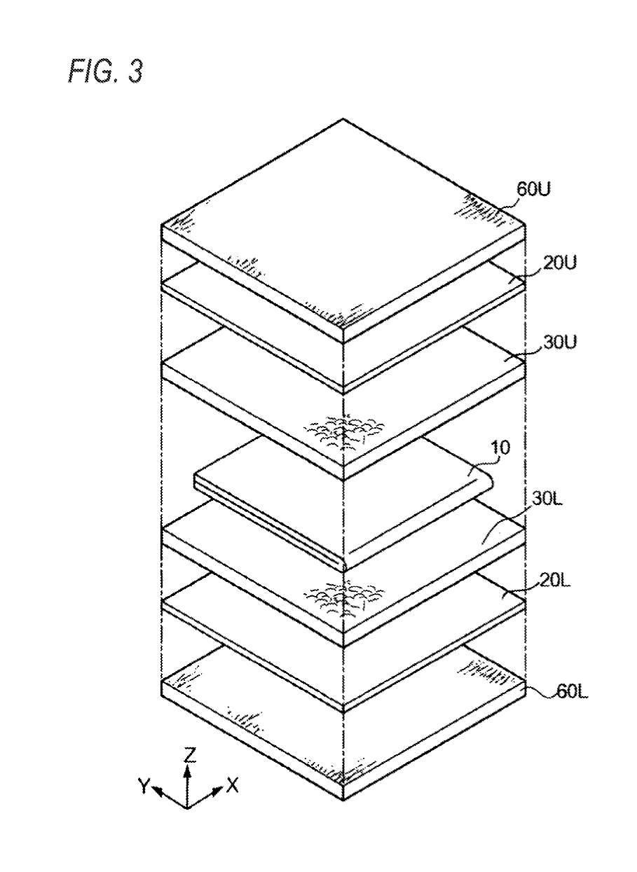

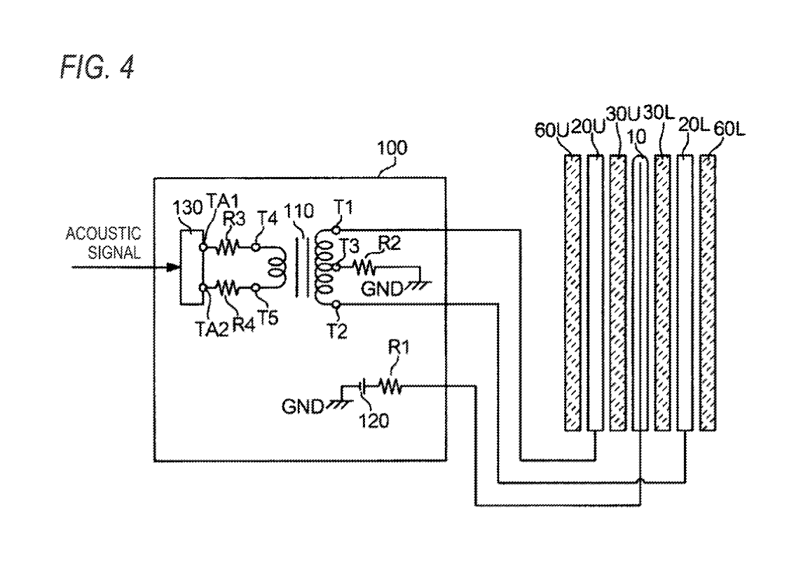

FIG. 1 is an external view showing an electrostatic loudspeaker 1 according to an embodiment of the presently disclosed subject matter, and FIG. 2 is a sectional view showing the electrostatic loudspeaker 1, taken on line A-A. In addition, FIG. 3 is an exploded view showing the electrostatic loudspeaker 1, and FIG. 4 is a view showing the electrical configuration of the electrostatic loudspeaker 1. In these figures, the X, Y, and Z axes perpendicular to one another indicate directions, and it is assumed that the left-right direction as viewed from the front of the electrostatic loudspeaker 1 is the X-axis direction, that the depth direction is the Y-axis direction, and that the height direction is the Z-axis direction. Besides, it is assumed that “•” written in “o” in each figure means an arrow directed from the back to the front of the figure. Moreover, “x” written in “o” in each figure means an arrow directed from the front to the back of the figure.

As shown in the figures, the electrostatic loudspeaker 1 has a vibrating member 10, electrodes 20U and 20L, elastic members 30U and 30L, and protection members 60U and 60L. In this embodiment, the configurations of the electrode 20U and the electrode 20L are the same, and the configurations of the elastic member 30U and the elastic member 30L are the same. Hence, in the case that it is not particularly necessary to distinguish between the two in these members, the descriptions of “L” and “U” are omitted. Furthermore, since the configuration of the protection member 60U and that of the protection member 60L are the same, in the case that it is not particularly necessary to distinguish between the two, that is, the protection members 60U and 60L, the descriptions of “L” and “U” are also omitted. Moreover, the dimensions of the respective components, such as the vibrating member and the electrodes, shown in the figures are made different from the actual dimensions thereof so that the shapes of the components can be understood easily.

(Configurations of the Respective Components of the Electrostatic Loudspeaker 1)

First, various sections constituting the electrostatic loudspeaker 1 will be described. The vibrating member 10 having a rectangular shape as viewed from a point on the Z-axis has a configuration in which a sheet is formed by using a film (insulation layer) of a synthetic resin having insulation property and flexibility, such as PET (polyethylene terephthalate) or PP (polypropylene), as a base material and by forming a conductive membrane (conductive layer) by evaporating a conductive metal on one face of the film, and the sheet is folded into two parts. More specifically, the vibrating member 10 is configured by applying an adhesive to the conductive membrane of the sheet before the sheet is folded into two parts and by folding the sheet into two parts so that the conductive membrane is disposed inside and so that the conductive membrane portions being opposed to each other are bonded to each other. In the vibrating member 10, since the sheet is folded into two parts with the conductive membrane disposed inside, the synthetic resin film covers the conductive membrane and the synthetic resin film is exposed to the outside.

In this embodiment, the elastic member 30 is made of non-woven cloth, does not conduct electricity, allows air and sound to pass therethrough, and has a rectangular shape as viewed from a point on the Z-axis. In addition, the elastic member 30 has elasticity, and it is deformed when an external force is applied thereto and returns to its original shape when the external force is removed. The elastic member 30 may be a member having insulation property, acoustic transmission property, and elasticity; furthermore, the elastic member may also be a member obtained by heating and compressing inner cotton, a member made of woven cloth, or a member obtained by forming a synthetic resin having insulation property into a spongy shape. In this embodiment, the length of the elastic member 30 in the X-axis direction is longer than the length of the vibrating member 10 in the X-axis direction, and the length of the elastic member 30 in the Y-axis direction is longer than the length of the vibrating member 10 in the Y-axis direction.

The electrode 20 has a configuration in which a film (insulation layer) of a synthetic resin having insulation property, such as PET or PP, is used as a base material and a conductive metal is evaporated on one face of the film to form a conductive membrane (conductive layer). The electrode 20 has a rectangular shape as viewed a point on the Z-axis, has a plurality of through-holes passing through from the front face to the back face, and allows air and sound to pass therethrough. These holes are not shown in the figures. Furthermore, in this embodiment, the length of the electrode 20 in the X-axis direction and the length thereof in the Y-axis direction are the same as those of the elastic member 30.

The protection member 60 is a cloth having insulation property. The protection member 60 has a rectangular shape as viewed a point on the Z-axis and allows air and sound to pass therethrough. In this embodiment, the length of the protection member 60 in the X-axis direction and the length thereof in the Y-axis direction are the same as those of the elastic member 30.

(Structure of the Electrostatic Loudspeaker 1)

Next, the structure of the electrostatic loudspeaker 1 will be described. In the electrostatic loudspeaker 1, the vibrating membrane 10 is disposed between the lower face of the elastic member 30U and the upper face of the elastic member 30L. An adhesive is applied to the vibrating member 10 in a width of several mm from the fringes in the left-right direction and from the fringes in the depth direction to the inside, and the vibrating member 10 is bonded to the elastic member 30U and the elastic member 30L, whereby the inside from the portion to which the adhesive is applied is not firmly bonded to the elastic member 30U and the elastic member 30L.

The electrode 20U is bonded to the upper face of the elastic member 30U. Furthermore, the electrode 20L is bonded to the lower face of the elastic member 30L. An adhesive is applied to the electrode 20U in a width of several mm from the fringes in the left-right direction and from the fringes in the depth direction to the inside, and the electrode 20U is bonded to the elastic member 30U; and an adhesive is applied to the electrode 20L in a width of several mm from the fringes in the left-right direction and from the fringes in the depth direction to the inside, and the electrode 20L is bonded to the elastic member 30L. The inside of the electrode 20 from the portion to which the adhesive is applied is not firmly bonded to the elastic member 30. Furthermore, the conductive membrane side of the electrode 20U makes contact with the elastic member 30U, and the conductive membrane side of the electrode 20L makes contact with the elastic member 30L.

The protection member 60U is bonded to the upper face of the electrode 20U. Furthermore, the protection member 60L is bonded to the lower face of the electrode 20L. An adhesive is applied to the protection member 60U in a width of several mm from the fringes in the left-right direction and from the fringes in the depth direction to the inside, and the protection member 60U is bonded to the electrode 20U; and an adhesive is applied to the protection member 60L in a width of several mm from the fringes in the left-right direction and from the fringes in the depth direction to the inside, and the protection member 60L is bonded to the electrode 20L. The inside of the protection member 60 from the portion to which the adhesive is applied is not firmly bonded to the electrode 20.

(Electrical Configuration of the Electrostatic Loudspeaker 1)

Next, the electrical configuration of the electrostatic loudspeaker 1 will be described. As shown in FIG. 4, a drive circuit 100 equipped with an amplifier section 130 to which an acoustic signal representing sound is input, a transformer 110, and a bias supply 120 for supplying a DC bias to the vibrating member 10 is connected to the electrostatic loudspeaker 1.

The electrode 20U is connected to one secondary side terminal T1 of the transformer 110, and the electrode 20L is connected to the other secondary side terminal T2 of the transformer 110. In addition, the vibrating member 10 is connected to the bias supply 120 via a resistor R1. The middle point terminal T3 of the transformer 110 is connected to the ground GND having the reference potential of the drive circuit 100 via a resistor R2.

An acoustic signal is input to the amplifier section 130. The amplifier section 130 amplifies the input acoustic signal and outputs an amplified acoustic signal. The amplifier section 130 has terminals TA1 and TA2 for outputting the acoustic signal; the terminal TA1 is connected to one primary side terminal T4 of the transformer 110 via a resistor R3, and the terminal TA2 is connected to the other primary side terminal T5 of the transformer 110 via a resistor R4.

(Operation of the Electrostatic Loudspeaker 1)

Next, the operation of the electrostatic loudspeaker 1 will be described. When an AC acoustic signal is input to the amplifier section 130, the input acoustic signal is amplified and supplied to the primary side of the transformer 110. Then, acoustic signals, the voltages of which are stepped up by the transformer 110, are supplied to the electrodes 20; when a potential difference occurs between the electrode 20U and the electrode 20L, an electrostatic force is exerted to the vibrating member 10 disposed between the electrode 20U and the electrode 20L such that the vibrating member 10 is attracted to either the electrode 20U or the electrode 20L.

More specifically, the polarity of a second acoustic signal output from the terminal T2 is opposite to that of a first acoustic signal output from the terminal T1. When a plus acoustic signal is output from the terminal T1 and a minus acoustic signal is output from the terminal T2, a plus voltage is applied to the electrode 20U, and a minus voltage is applied to the electrode 20L. Since a plus voltage has been applied from the bias supply 120 to the vibrating member 10, the electrostatic attraction force between the vibrating member 10 and the electrode 20U to which the plus voltage is applied becomes weak; on the other hand, the electrostatic attraction force between the vibrating member 10 and the electrode 20L to which the minus voltage is applied becomes strong. An attraction force is exerted to the vibrating member 10 so as to move it toward the electrode 20L depending on the difference between the electrostatic attraction forces exerted to the vibrating member 10, and the vibrating member 10 is displaced toward the electrode 20L (in the direction opposite to the Z-axis direction).

Furthermore, when a minus first acoustic signal is output from the terminal T1 and a plus second acoustic signal is output from the terminal T2, a minus voltage is applied to the electrode 20U, and a plus voltage is applied to the electrode 20L. Since the plus voltage has been applied from the bias supply 120 to the vibrating member 10, the electrostatic attraction force between the vibrating member 10 and the electrode 20L to which the plus voltage is applied becomes weak; on the other hand, the electrostatic attraction force between the vibrating member 10 and the electrode 20U to which the minus voltage is applied becomes strong. An attraction force is exerted to the vibrating member 10 so as to move it toward the electrode 20U depending on the difference between the electrostatic attraction forces exerted to the vibrating member 10, and the vibrating member 10 is displaced toward the electrode 20U (in the Z-axis direction).

In this way, the vibrating member 10 is displaced (deflected) in the positive direction of the Z-axis and in the negative direction of the Z-axis in the figure depending on the acoustic signal, and the direction of the displacement changes sequentially, whereby vibration is generated and a sound wave corresponding to the vibration state (frequency, amplitude and phase) is generated from the vibrating member 10. The generated sound wave passes through the elastic members 30, the electrodes 20 and the protection members 60 having acoustic transmission property, and is radiated as sound to the outside of the electrostatic loudspeaker 1.

The vibrating member 10 is folded into two parts, and a film having insulation property is disposed between the electrode 20U and the conductive membrane and between the electrode 20L and the conductive membrane; hence, with respect to the dielectric strength voltage between the electrode and the vibrating member, the difference between the voltage on the side of the electrode 20U and the voltage on the side of the electrode 20L can be suppressed from occurring, and short circuit can be suppressed from occurring even if the electrostatic loudspeaker is folded or bent.

In addition, according to this embodiment, a synthetic resin film having insulation property is positioned between the conductive membrane of the vibrating member 10 and the electrode 20U and between the conductive membrane of the vibrating member 10 and the electrode 20L. For this reason, in comparison with a configuration in which no synthetic resin film is positioned between the conductive membrane and the electrode 20, the dielectric strength voltage between the electrode 20 and the vibrating member 10 can be raised, whereby the DC bias voltage to be applied to the vibrating member 10 can be raised. In the electrostatic loudspeaker, the sound pressure of the loudspeaker is determined by the product of the DC bias voltage and the voltage of the acoustic signal to be applied to the electrode 20; hence, the voltage of the acoustic signal to be applied to the electrode 20 can be made lower than that in the configuration in which no synthetic resin film is positioned between the conductive membrane and the electrode 20, by raising the DC bias voltage.

Furthermore, if the protection member 60 is broken, there is a danger that the electrode 20 may make contact with a human body; however, in this embodiment, the voltage of the acoustic signal to be applied to the electrode 20 can be made lower than that in the configuration in which no synthetic resin film is positioned between the conductive membrane and the electrode 20, whereby measures for electric shock can be made simple.

In this embodiment, since the vibrating member 10, the electrodes 20, the elastic members 30, and the protection members 60 have flexibility, the electrostatic loudspeaker can be folded, bent or rounded into a cylindrical shape without having a specific shape and can be conveyed in a down-sized state. Furthermore, since these components have flexibility, the electrostatic loudspeaker can be used in a suspended state as in the case of a blind, a curtain or a short split curtain, for example. Moreover, since these components have flexibility and can easily be deformed into a specific shape, the electrostatic loudspeaker can be secured to a wall or a ceiling using adhesive tape, double-faced adhesive tape, surface fastener, etc. Still further, in the case that no conductive membrane is provided at the fringes of the vibrating member 10 and the electrodes 20, it may be possible that the electrostatic loudspeaker is secured to a wall or a ceiling by passing pins through the portions thereof provided with no conductive membrane.

(Modification)

Although the embodiment according to the presently disclosed subject matter has been described above, the presently disclosed subject matter can be embodied into other various modes without being limited to the above-mentioned embodiment. For example, the presently disclosed subject matter may be embodied by modifying the above-mentioned embodiment as described below. Furthermore, the above-mentioned embodiment and various modifications described below may be combined.

In the above-mentioned embodiment, the electrostatic loudspeaker 1 is equipped with the protection members 60; however, the electrostatic loudspeaker 1 may not be required to be equipped with the protection members 60.

In the above-mentioned embodiment, an adhesive is applied to the fringe portions of the respective members and the members are bonded to the other members; however, the portions to which the adhesive is applied are not limited to the fringe portions of the members. For example, the adhesive may be applied to the respective members in a grid shape and the members may be bonded to the other members. Furthermore, it may be possible that areas to which the adhesive is applied in dots are provided regularly in a matrix form, for example, on the respective members and the respective members are bonded to the other members.

Moreover, the method for preventing the members from being displaced from one another in the electrostatic loudspeaker 1 is not limited to the method for performing fixation using an adhesive, but double-faced adhesive tape, for example, may also be used to secure the members to one another.

In the above-mentioned embodiment, the electrode 20 has a configuration in which a conductive membrane is formed on the surface of the film; however, the configuration of the electrode 20 is not limited to this configuration. For example, a metal plate having conductivity may be used as the electrode 20. Furthermore, it may be possible that cloth woven with conductive threads is formed into a rectangular shape and this cloth formed into the rectangular shape is used as the electrode 20. Moreover, it may be possible that a conductive membrane is formed on a substrate obtained by forming a material (for example, glass or phenol resin) having insulation property into a plate shape and the member thus obtained is used as the electrode 20.

Still further, in the above-mentioned embodiment, the conductive membrane side of the electrode 20 is oriented to the elastic member 30; however, the conductive membrane side of the electrode 20 may be disposed so as to be oriented to the protection member 60.

In the above-mentioned embodiment, the electrode 20 has a rectangular shape as viewed from a point on the Z-axis; however, the shape of the electrode 20 is not limited to the rectangular shape. For example, other shapes, such as a circular shape, an elliptic shape, and a polygonal shape, may be used. Furthermore, also in the vibrating member 10, the shape thereof is not limited to the rectangular shape as viewed from a point on the Z-axis; for example, other shapes, such as a circular shape, an elliptic shape, and a polygonal shape, may be used. Moreover, the shape of the electrostatic loudspeaker 1 is not limited to the rectangular shape as viewed from a point on the Z-axis; for example, other shapes, such as a circular shape, an elliptic shape, and a polygonal shape, may be used.

In the above-mentioned embodiment, the elastic member 30 is disposed between the electrode 20 and the vibrating member 10 so that the electrode 20 does not make contact with the vibrating member 10; however, the configuration structured so that the electrode 20 does not make contact with the vibrating member 10 is not limited to the configuration of the above-mentioned embodiment. For example, the electrode 20 may be prevented from making contact with the vibrating member 10 by disposing a spacer formed of an insulator between the electrode 20 and the vibrating member 10. FIG. 5 is an exploded view showing an electrostatic loudspeaker according to this modification. Spacers 31U and 31L are formed of plastic made of a synthetic resin having insulation property, and the shape thereof is a rectangular frame shown in FIG. 5. In this modification, the height of the spacer 31U and the height of the spacer 31L are the same.

In the electrostatic loudspeaker 1, the electrode 20L is secured to the lower face of the spacer 31L and the electrode 20U is secured to the upper face of the spacer 31U. In addition, the vibrating member 10 is firmly bonded to the upper face of the spacer 31L and the lower face of the spacer 31U is firmly bonded to the upper face of the vibrating member 10.

In this modification, the vibrating member 10 is secured between the frames of the spacer 31U and the spacer 31L in a state of being subjected to a tension force so as not to become loose. With this configuration, a distance is preserved between the electrode 20 and the vibrating member 10 using the spacers 31U and 31L, whereby the vibrating member 10 does not make contact with the electrode 20 even if the vibrating member 10 vibrates.

The vibrating member 10 according to the above-mentioned embodiment is configured such that the sheet having the conductive membrane formed on one face of the synthetic resin film is folded into two parts; however, it may also be possible to use a configuration in which a conductive membrane is formed on a synthetic resin film and the conductive membrane is further covered with a synthetic resin film, whereby the synthetic resin films are stacked on both faces of the conductive membrane. Furthermore, in the above-mentioned embodiment, the vibrating member 10 may be configured such that two sheets, each having a conductive membrane on one face of a synthetic resin film, are bonded to each other so that the conductive membranes are disposed inside.

In the above-mentioned embodiment, the vibrating member 10 is folded into two parts and disposed between the elastic member 30U and the elastic member 30L; however, the vibrating member 10 may be folded using a method other than that described in the above-mentioned embodiment, provided that the synthetic resin film side thereof is oriented to the side of the elastic member 30, and the vibrating member 10 may be disposed between the elastic member 30U and the elastic member 30L.

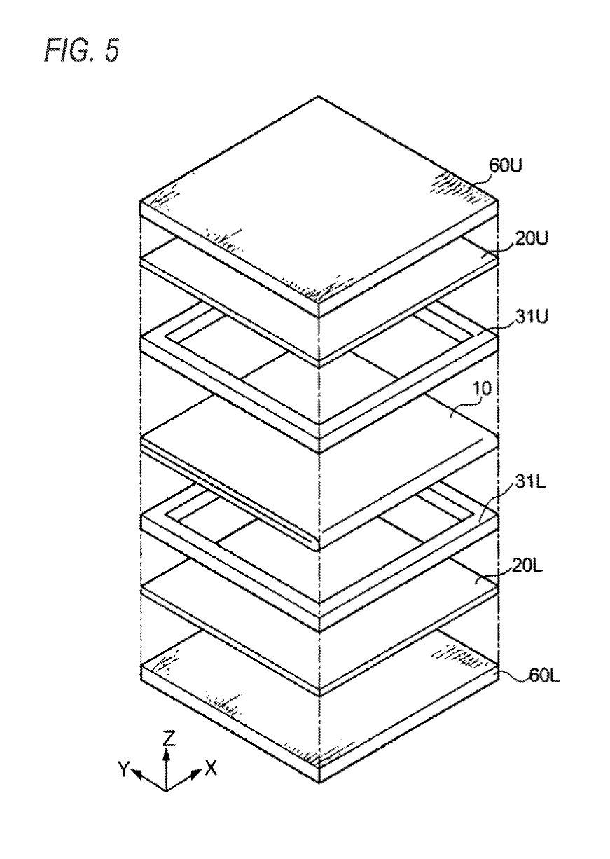

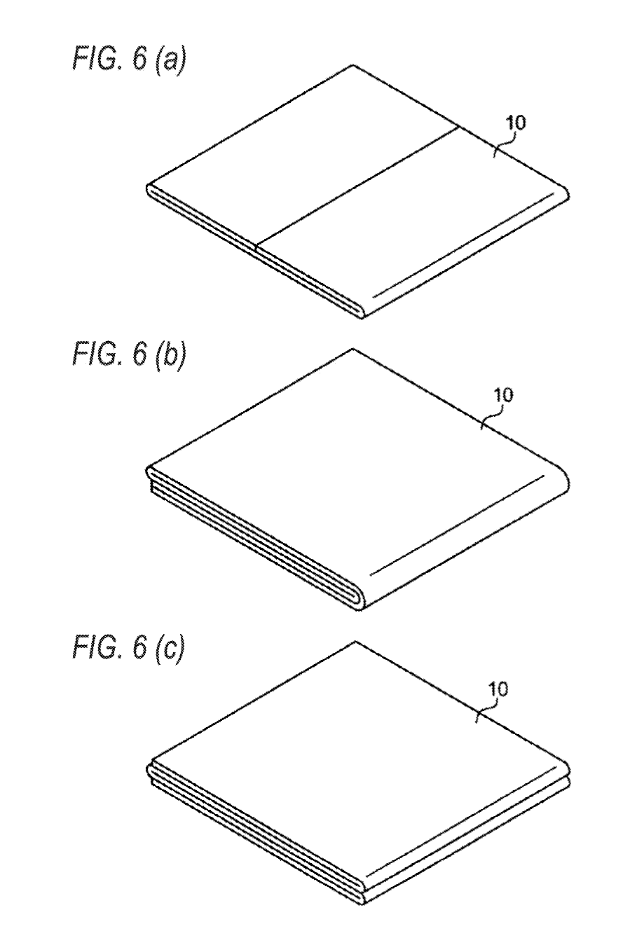

For example, as shown in FIG. 6(a), the vibrating member 10 may be folded such that both ends thereof in the X-axis direction are positioned at the center of the vibrating member 10. Furthermore, as shown in FIG. 6(b), the vibrating member 10 having been folded into two parts may further be folded into two parts. Moreover, as shown in FIG. 6(c), it may be possible that a sheet having a conductive membrane formed on one face of a synthetic resin film is mountain-folded and valley-folded alternately so that the synthetic resin film side of the sheet is oriented to the elastic members 30U and 30L.

Furthermore, in the above-mentioned embodiment, the vibrating member 10 having the conductive layer and the insulation layer is folded into two parts and disposed; however, a conductive layer and an insulation layer, being independent of each other, may also be used. In other words, the insulation layer should only be disposed between the electrode 20 and the vibrating member, regardless of the position where the insulation layer is disposed. For example, the insulation layer independent of the conductive layer may be disposed so as to make contact with the electrode 20.

(Method for Producing the Vibrating Member 10)

In the above-mentioned embodiment, the sheet having the conductive layer and the insulation layer is folded into two parts so that the conductive layer of the vibrating member 10 is disposed inside and the insulation layer thereof is disposed outside; however, the method for producing the vibrating member 10 so that the insulation layer is disposed outside is not limited to this method.

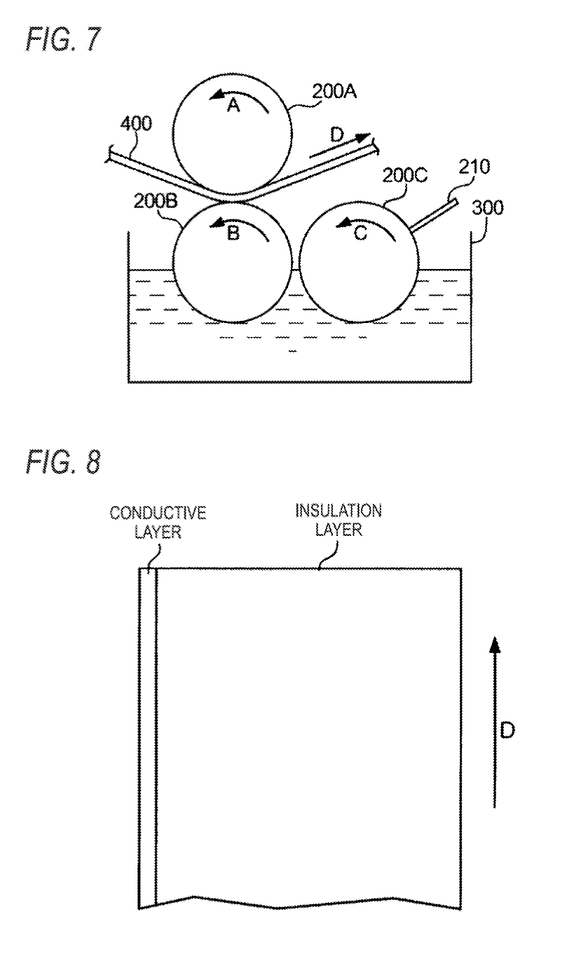

For example, a sheet having an insulation layer and a conductive layer stacked thereon may be processed using a roll coating method so that the conductive layer is covered with the insulation layer. FIG. 7 is a schematic view showing an apparatus for producing a sheet in which a conductive layer is covered with a synthetic resin using a reverse roll coating method (reverse roll coater). Rolls 200A to 200C are rolls having a cylindrical shape and are respectively rotated in the directions indicated by the arrows A to C shown in the figure. A blade 210, a plate-like component, is made contact with the surface of the roll 200C. The rolls 200A to 200C are dipped in a synthetic resin solution 300 having insulation property. The roll 200A is opposed to the roll 200B with a clearance provided therebetween. Between the roll 200A and the roll 200B, a sheet 400 having an insulation layer and a conductive layer stacked thereon is conveyed in the direction indicated by the arrow D shown in the figure so that the insulation layer makes contact with the roll 200A.

When the roll 200C rotates, the solution 300 lifted from the surface of the roll 200C is scraped off using the blade 210. On the other hand, the solution 300 lifted using the roll 200B is fed to the sheet 400. More specifically, the solution 300 lifted using the roll 200B is partly scraped off by virtue of the clearance between the surface of the roll 200B and the surface of the roll 200C from which the solution 300 has been scraped off, and the rest of the solution 300 is fed to the roll 200A. The amount of the solution 300 to be fed to the sheet 400 is determined by the clearance between the roll 200B and the roll 200C and by the rotation speed of the rolls.

The solution 300 lifted using the roll 200B is applied to the sheet conveyed to the clearance between the roll 200A and the roll 200B. Since the conductive layer of the sheet 400 is oriented to the roll 200B, the solution 300 is applied to the surface of the conductive layer. When the solution 300 is applied to the surface of the conductive layer, the conductive layer is covered with the synthetic resin having insulation property; as a result, the insulation layers are stacked on both the front and back faces of the conductive layer.

The method for coating the conductive layer side of the sheet 400 with a material having insulation property is not limited to the above-mentioned reverse roll coating method, but other methods may also be used.

In addition, when the conductive layer side of the sheet 400 is coated with a material having insulation property, instead of coating the entire face of the conductive layer with the insulation layer, the coating may not be performed in a predetermined range from the end of the conductive layer in the conveying direction. With this method, when the vibrating member 10 is formed by cutting the sheet 400 coated with the conductive layer, wiring to the conductive layer can be performed easily because the conductive layer is exposed. In the case that wiring is performed to the conductive layer, it may be possible that conductive tape is attached to the portion in which the conductive layer is exposed and the wiring is soldered to the attached conductive tape, or the wiring is attached to the conductive layer with conductive tape. Furthermore, in the case that the wiring is soldered to the conductive tape, the length of the conductive tape may be made longer as the current flowing through the vibrating member 10 is larger. Moreover, in the above-mentioned configuration in which the conductive tape is attached to the conductive layer and the wiring is soldered to the conductive tape, the portion in which the conductive layer is exposed may be positioned on the outside of the electrode 20 when the electrostatic loudspeaker 1 is viewed from above.

In addition, the method for coating the conductive layer side of the sheet 400 with a material having insulation property is not limited to the above-mentioned methods. The conductive layer side of the sheet 400 may be coated with a material having insulation property by applying the material having insulation property to the conductive layer side of the sheet 400 using spray coating. With this method, an insulator is applied to the surface of the conductive layer; eventually, the insulation layers are stacked on both the front and back faces of the conductive layer.

Furthermore, the method for producing the vibrating member 10 having the insulation layers disposed outside is not limited to the method in which a material having insulation property is applied to the surface of the conductive layer. For example, two sheets, each having an insulation layer and a conductive layer stacked thereon, may be stacked and bonded to each other so that the conductive layers of the respective sheets make contact with each other. With this method, since only the two sheets are required to be stacked, it is possible to easily obtain a sheet having a conductive layer covered with insulation layers.

Moreover, the vibrating member 10 may also be formed by laminating a sheet having insulation property on the surface of the conductive layer of a sheet having an insulation layer and a conductive layer stacked thereon, or by laminating a sheet having insulation property on each of both faces of a sheet-like conductive layer.

The sheet having the insulation layers on both the front and back faces of the conductive layer, produced using the above-mentioned production method, may also be used as the vibrating member 10. In this case, since the front and back faces of the conductive layer are coated with the insulation layers, the sheet may be used as the vibrating member 10 without being folded into two parts. Since the insulation layers are stacked on the front and back faces of the conductive layer without folding the sheet, with respect to the dielectric strength voltage between the electrode and the vibrating member, the difference between the voltage on the side of the electrode 20U and the voltage on the side of the electrode 20L can be suppressed from occurring, and short circuit can be suppressed from occurring even if the electrostatic loudspeaker is folded or bent.

Furthermore, when the conductive layer side of the sheet 400 is coated with a material having insulation property, the entire face of the conductive layer may be coated with the material having insulation property. In this case, it may be possible that a component having a shape of the needle of a stapler and having conductivity is inserted into the vibrating member 10 and the tip ends thereof are bent so as to be secured to the vibrating member 10. When passing through the conductive layer of the vibrating member 10, the component having conductivity makes contact with the conductive layer; hence, a bias voltage can be applied to the conductive layer by soldering the component to the wiring. In the case that a component having conductivity is passed through the conductive layer, the shape of the component is not limited to have the shape of the needle of a stapler. For example, the component may have three or more needle portions.

According to an aspect of the presently disclosed subject matter, it is possible to suppress a difference between the dielectric strength voltage between one electrode and the vibrating member on one face side of the vibrating member opposed to the electrode and the dielectric strength voltage between the other electrode and the vibrating member on the other face side of the vibrating member.

What is claimed is:

1. An electrostatic loudspeaker compressing:
a first electrode;
a second electrode which is opposed to the first electrode; and
a vibrating member which is disposed between the first electrode and the second electrode and in which an insulation membrane and a conductive membrane are stacked, the insulation membrane being disposed on both end faces of the vibrating member in a direction of the stacking.

2. The electrostatic loudspeaker according to claim 1, wherein the vibrating member is formed by folding a sheet in which the conductive membrane is formed on the insulation membrane.

3. The electrostatic loudspeaker according to claim 2, wherein the vibrating member is formed by folding the sheet into two parts.

4. The electrostatic loudspeaker according to claim 1, wherein the vibrating member is formed by stacking two sheets, in which the insulation membrane and the conductive membrane are stacked, so that the insulation membrane is disposed outside.

5. A method of producing an electrostatic loudspeaker, the method comprising:
a first step of stacking an insulation membrane and a conductive membrane to form a vibrating member, the insulation membrane being disposed on both end faces of the vibrating member in a direction of the stacking; and
a second step of disposing a first electrode, a second electrode and the vibrating member so that the vibrating member formed in the first step is disposed between the first electrode and the second electrode which are opposed to each other.

6. The method according to claim 5, wherein, in the first step, an insulator is applied to a surface of the conductive membrane of a sheet in which the insulation membrane and the conductive membrane are stacked, to form the vibrating member.

7. The method according to claim 5, wherein, in the first step, a sheet in which then insulation membrane and the conductive membrane are stacked is folded so that the insulation membrane is disposed outside, to form the vibrating member.

8. The method according to claim 5, wherein, in the first step, two sheets, in which the insulation membrane and the conductive membrane are stacked, are stacked so that the insulation membrane is disposed outside, to form the vibrating member.
